(19) United States
(12) Patent Application Publication
(10) Pub. No.: US 2026/0312674 A1
(43) Pub. Date: Oct. 8, 2026

(54) DUAL LAYER SATELLITE NETWORK COVERAGE

(71) Applicant: T-MOBILE INNOVATIONS LLC, Overland Park, KS (US)

(72) Inventor: Akin OZOZLU, McLean, VA (US)

(21) Appl. No.: 19/170,989

(22) Filed: Apr. 4, 2025

(51) Int. Cl. H04B 7/185; H04L 41/5009; H04W 36/00

(52) U.S. Cl. CPC H04B 7/18541; H04B 7/18589; H04L 41/5009; H04W 36/0058

(57) ABSTRACT

Embodiments of the present disclosure are directed to systems and methods that address coverage gaps in satellite-based wireless networks by enabling user equipment (UE) to connect to higher orbit satellites, such as those in Medium Earth Orbit (MEO), when Low Earth Orbit (LEO) coverage is weak or unavailable. The UE will handover to a lower-altitude satellite when it becomes available, ensuring consistent and reliable connectivity. This approach leverages higher altitude satellites as a fallback layer, enhancing network performance and coverage in underserved regions. By using higher altitude satellites for initial access and handover, the system mitigates service disruptions and improves user experience.

### SUMMARY

The present disclosure is directed to providing wireless coverage to a user equipment (UE) using a dual-layer satellite network, substantially as shown and/or described in connection with at least one of the Figures, and as set forth more completely in the claims.

The present disclosure addresses the challenges of intermittent coverage gaps in satellite-based wireless networks, particularly those using non-geostationary satellites in Low Earth Orbit (LEO). These networks use spot beams to enhance spectral efficiency and network capacity. However, non-geostationary satellite constellations, especially those in Low Earth Orbit (LEO), face challenges with intermittent or incomplete coverage, particularly at the boundaries between adjacent spot beams. This can lead to service disruptions, failed handovers, and connectivity loss for user equipment (UE). Traditional methods to address these issues include careful planning of satellite constellations, overlapping spot beams, beam redundancy, and beam-hopping techniques. Lower-frequency bands can offer better coverage but require larger antennas, increasing atmospheric drag and reducing satellite lifespan. Higher orbital regimes like Medium Earth Orbit (MEO) or Geostationary Orbit (GEO) provide broader coverage but result in higher latency and reduced signal strength. Terrestrial network fallback is often impractical in regions relying on satellite connectivity. The present disclosure proposes a system where a UE experiencing weak or no coverage from a LEO satellite will connect to a higher orbit satellite (e.g., MEO) and handover to a lower-altitude satellite when available. This approach ensures more consistent satellite coverage and improved network performance, particularly as lower-altitude satellite layers are densified.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE DRAWINGS

Aspects of the present disclosure are described in detail herein with reference to the attached Figures, which are intended to be illustrative and non-limiting, wherein:

FIG. 1 illustrates a computing device for use with the present disclosure;

FIG. 2 illustrates a network environment in which implementations of the present disclosure may be employed;

FIGS. 3A-3C illustrates a satellite network environment in which implementations of the present disclosure may be employed;

FIG. 4 depicts a flow diagram of a method for performing an initial access procedure in a satellite network environment, in accordance with embodiments described herein; and

FIG. 5 depicts a flow diagram of a method for performing a handover in a satellite network environment, in accordance with embodiments described herein.

### DETAILED DESCRIPTION

By way of background, satellite-based wireless networks, or satellite radio access networks (satellite RANs), increasingly serve an essential role in providing connectivity to user equipment (UE), particularly in remote, rural, maritime, aviation, or otherwise underserved areas where terrestrial wireless networks may be unavailable, impractical, or insufficiently deployed. Such satellite networks commonly utilize spot beams, which are localized, high-intensity beams that concentrate signal energy within defined geographic footprints to improve spectral efficiency and increase network capacity through frequency reuse. However, satellite RANs, particularly those deployed as constellations of non-geostationary satellites—such as satellites operating in Low Earth Orbit (LEO)—frequently encounter challenges related to intermittent or incomplete coverage. Specifically, these coverage gaps may arise at boundaries between adjacent spot beams provided either by a single satellite or by two different satellites within the constellation. These gaps are especially problematic in less dense satellite constellations, where beam-to-beam overlap may be minimal or entirely absent, causing UEs attempting a handover between beams to temporarily lose connectivity. In such scenarios, the UE may experience service disruptions, failed handover attempts, or complete loss of connectivity. Relatedly, initial access failures may also occur when a UE attempts to connect to the satellite network initially from a location outside or near the edge of satellite spot beam coverage, resulting in unsuccessful random access attempts, poor service reliability, degraded user experience, and inefficient network resource utilization.

Conventionally, satellite RAN systems attempt to mitigate coverage gaps and initial access failures primarily through careful planning of satellite constellations and their beam footprints. Operators typically deploy constellations with overlapping spot beams, additional beam redundancy, or utilize beam-hopping techniques designed to minimize, but often not fully eliminate, coverage gaps. Alternatively, operators may consider using lower-frequency bands, which naturally exhibit greater beamwidth, potentially offering improved coverage overlap and fewer gaps. However, such lower frequencies necessitate physically larger antennas aboard the satellites, significantly increasing atmospheric drag and consequently accelerating orbital decay, particularly in low Earth orbit (LEO). As such, the practical use of lower frequencies is substantially limited or discouraged due to increased operational complexity, propulsion requirements, and reduced satellite lifespan. Additionally, operators may consider placing satellites in higher orbital regimes, such as medium Earth orbit (MEO) or geostationary orbit (GEO), to provide broader and more persistent coverage areas and reduce handover-related disruptions. Yet, increasing orbital altitude results in significantly higher latency and reduced signal strength, thereby degrading network performance for latency-sensitive or high-throughput applications. Furthermore, fallback or supplemental coverage provided by terrestrial networks is often unavailable or impractical, especially in regions specifically relying on satellite-based connectivity due to geographic or economic constraints. Accordingly, conventional methods either inadequately address the underlying connectivity issues or introduce additional practical, economic, and technical challenges.

Unlike conventional options, the present disclosure is directed to systems and methods for mitigating disruptions in satellite coverage. A UE that is experiencing weak or no coverage from a satellite in low earth orbit (LEO) will search and select a satellite in a higher orbit, such as medium earth orbit (MEO). Once a lower-altitude satellite become available, the UE will handover to the lower-altitude satellite. In aspects, the selection of the higher altitude satellite may be used for initial access; that is, when the UE first establishes a communication link, enabling it to connect and begin exchanging data. In other aspects, the higher altitude satellite may be relied on during handover; that is, the UE will be transferred from a first lower altitude satellite to a higher altitude satellite when a second lower altitude satellite (or a second spot beam from the first lower altitude satellite) is unavailable. Using the higher altitude as a fallback layer to the lower altitude satellite will allow network operators to create more consistent satellite coverage areas, particularly as lower altitude satellite layers with more capacity are densified.

Accordingly, a first of the present disclosure is directed to a user equipment (UE) configured to wirelessly communicate with a satellite radio access network. The UE comprises one or more antennas configured to wirelessly communicate with the satellite radio access network, and one or more computer processing components configured to perform operations. The operations comprise determining, based on a measurement of a first set of signals received from a first satellite, that one or more key performance indicators (KPIs) of the first set of signals are worse than a predetermined threshold. Responsive to said determination, the UE monitors a first set of frequencies for one or more synchronization signals, the first set of frequencies used by a first set of satellites. Based on a failure to detect one or more synchronization signals from the first set of satellites having one or more KPIs greater than a cell selection threshold, the UE monitors a second set of frequencies for one or more synchronization signals transmitted by a second set of satellites. The UE communicates a first measurement report to the first satellite that one or more synchronization signals transmitted by a second satellite are greater than the cell selection threshold. Finally, the UE receives an instruction from the first satellite to handover to the second satellite.

Another aspect of the present disclosure is directed to a method for performing handovers in a wireless network environment. The method comprises determining, based on a measurement of a first set of signals received from a first satellite, that one or more key performance indicators (KPIs) of the first set of signals are worse than a predetermined threshold. Responsive to this determination, the method includes monitoring a first set of frequencies for one or more synchronization signals, where the first set of frequencies is used by a first set of satellites. Based on a failure to detect one or more synchronization signals from the first set of satellites having KPIs greater than a cell selection threshold, the method involves monitoring a second set of frequencies for one or more synchronization signals transmitted by a second set of satellites. The method further includes communicating a first measurement report to the first satellite, indicating that one or more synchronization signals transmitted by a second satellite are greater than the cell selection threshold. Finally, the method comprises receiving an instruction from the first satellite to handover to the second satellite.

Another aspect of the present disclosure is directed to a method for performing initial access in a wireless network environment. The method comprises performing a primary cell search operation for a first set of satellites, which involves monitoring one or more frequencies for signals transmitted by a satellite of the first set of satellites. The method further includes determining that the primary cell search operation failed. Responsive to the failure of the primary cell search operation, the method involves performing a secondary cell search operation for a second set of satellites, which comprises monitoring one or more frequencies for signals transmitted by a satellite of the second set of satellites. The method includes determining that the signals transmitted by the satellite of the second set of satellites meet a minimum access criteria. Finally, responsive to this determination, the method comprises initiating initial access with the satellite of the second set of satellites.

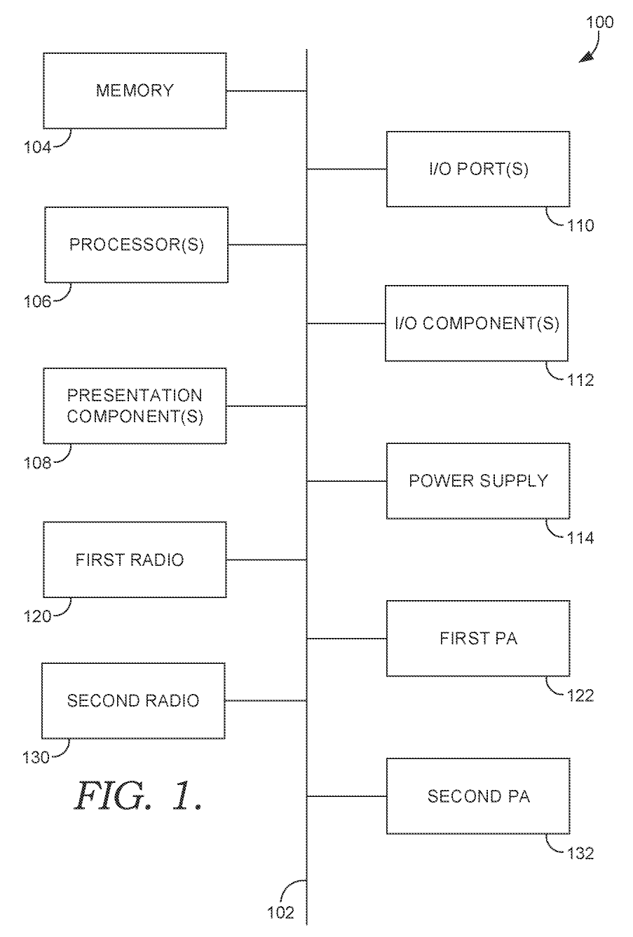

Referring to FIG. 1, a representative computer environment is shown and designated generally as computing device 100 that is suitable for use in implementations of the present disclosure. Computing device 100 is but one example of a suitable computing environment and is not intended to suggest any limitation as to the scope of use or functionality of the invention. Neither should computing device 100 be interpreted as having any dependency or requirement relating to any one or combination of components illustrated. In aspects, the computing device 100 is generally defined by its capability to transmit one or more signals to an access point and receive one or more signals from the access point (or some other access point); the computing device 100 may be referred to herein as a user equipment, wireless communication device, or user device. The computing device 100 may take the form of a wireless access device that acts as a more localized and consolidated access point that provides end user wireless devices access to a broader network; examples of wireless access devices include fixed wireless access (FWA) devices and mobile hotspots. The computing device 100 may take the form of a mobile device, used herein to refer to categories of often-portable devices that utilize a wireless connection to a broader network and are typically configured for direct human interaction and personal computing tasks; examples of mobile devices include smartphones, tablets, extended reality (XR) devices (e.g., virtual reality, augmented reality, or mixed reality devices), computers (e.g., laptops and PCs), wearable devices (e.g., smartwatches, fitness tracker), electronic readers (i.e., an e-book reader or digital book reader), portable media player, handheld GPS/location device, digital camera, gaming console, and digital voice recorders. The computing device may take the form of a connected vehicle that integrates advanced communication and computing technologies to interact with other devices and networks, encompassing vehicle to vehicle (V2V) communications, vehicle to infrastructure (V2I) communications, and/or vehicle to everything (V2X) communications, and that utilizes a wireless connection to support telematics, infotainment systems, over the air updates, vehicle health monitoring, and/or enhanced navigation; examples of connected vehicles include automotive, locomotive, airborne, and cargo (e.g., train car, semi-trailer) systems. The computing device 100 may take the form of an Internet of Things (IoT) device, a physical object embedded with sensors, software, or other technologies that enable them to collect, exchange, and act on data using an internet connection, which allows them to perform automated, decision-making or, other content-provision tasks; examples of IoT devices include smart home devices (e.g., smart thermostats, smart lights, power supply/management systems, and smart security systems), connected appliances (e.g., smart refrigerators), health monitoring devices (e.g., blood pressure monitor, glucose monitor), industrial devices (e.g., smart sensors, predictive maintenance systems), and agricultural devices (e.g., soil, environmental, or growth sensors).

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

With continued reference to FIG. 1, computing device 100 includes bus 102 that directly or indirectly couples the following devices: memory 104, one or more processors 106, one or more presentation components 108, input/output (I/O) ports 110, I/O components 112, and power supply 114. Bus 102 represents what may be one or more busses (such as an address bus, data bus, or combination thereof). Although the devices of FIG. 1 are shown with lines for the sake of clarity, in reality, delineating various components is not so clear, and metaphorically, the lines would more accurately be grey and fuzzy. For example, one may consider a presentation component such as a display device to be one of I/O components 112. Also, processors, such as one or more processors 106, have memory. The present disclosure hereof recognizes that such is the nature of the art, and reiterates that FIG. 1 is merely illustrative of one example of a computing environment that can be used in connection with one or more implementations of the present disclosure. Distinction is not made between such categories as “workstation,” “server,” “laptop,” “handheld device,” etc., as all are contemplated within the scope of FIG. 1 and refer to “computer” or “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media of the computing device 100 may be in the form of a dedicated solid state memory or flash memory, such as a subscriber information module (SIM). Computer storage media does not comprise a propagated data signal.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 104 includes computer-storage media in the form of volatile and/or nonvolatile memory. Memory 104 may be removable, nonremovable, or a combination thereof. The memory 104 may take the form of solid-state memory, hard drives, optical-disc drives, etc. Computing device 100 includes one or more processors 106 that read data from various entities such as bus 102, memory 104 or I/O components 112. One or more presentation components 108 presents data indications to a person or other device. The one or more presentation components 108 may comprise one or more of a display device, speaker, printing component, vibrating component, etc. I/O ports 110 allow computing device 100 to be logically coupled to other devices including I/O components 112, some of which may be built in computing device 100. Illustrative I/O components 112 include a microphone, joystick, game pad, satellite dish, scanner, printer, wireless device, etc.

A first radio 120 and a second radio 130 represent radios that facilitate communication with one or more wireless networks using one or more wireless links. In aspects, the first radio 120 utilizes a first transmitter 122 to communicate with a wireless network on a first wireless link and the second radio 130 utilizes the second transmitter 132 to communicate on a second wireless link. Though two radios are shown, it is expressly conceived that a computing device with a single radio (i.e., the first radio 120 or the second radio 130) could facilitate communication over one or more wireless links with one or more wireless networks via both the first transmitter 122 and the second transmitter 132. Illustrative wireless telecommunications technologies include CDMA, GPRS, TDMA, GSM, 802.11, and the like. One or both of the first radio 120 and the second radio 130 may carry wireless communication functions or operations using any number of desirable wireless communication protocols, including 802.11 (Wi-Fi), WiMAX, LTE, 3G, 4G, LTE, 5G, NR, VoLTE, or other VoIP communications. In aspects, the first radio 120 and the second radio 130 may be configured to communicate using the same protocol but in other aspects they may be configured to communicate using different protocols. In some embodiments, including those that both radios or both wireless links are configured for communicating using the same protocol, the first radio 120 and the second radio 130 may be configured to communicate on distinct frequencies or frequency bands (e.g., as part of a carrier aggregation scheme). As can be appreciated, in various embodiments, each of the first radio 120 and the second radio 130 can be configured to support multiple technologies and/or multiple frequencies; for example, the first radio 120 may be configured to communicate with a base station according to a cellular communication protocol (e.g., 4G, 5G, 6G, or the like), and the second radio 130 may be configured to communicate with one or more other computing devices according to a local area communication protocol (e.g., IEEE 802.11 series, Bluetooth, NFC, z-wave, or the like).

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various technical terms, acronyms, and shorthand notations are employed to describe, refer to, and/or aid the understanding of certain concepts pertaining to the present disclosure. Unless otherwise noted, said terms should be understood in the manner they would be used by one with ordinary skill in the telecommunication arts. An illustrative resource that defines these terms can be found in Newton's Telecom Dictionary, (e.g., 32nd Edition, 2022). As used herein, the terms “base station” or “access point” refer to a centralized component or system of components that is configured to wirelessly communicate (receive and/or transmit signals) with a plurality of stations (i.e., wireless communication devices, also referred to herein as user equipment (UE(s))) in a particular geographic area. As used herein, the term “network access technology (NAT)” is synonymous with wireless communication protocol and is an umbrella term used to refer to the particular technological standard/protocol that governs the communication between a UE and a base station; examples of network access technologies suitable for use with the present disclosure include but are not limited to 3G, 4G, 5G, 6G, 802.11x, and the like.

Embodiments of the technology described herein may be embodied as, among other things, a method, system, or computer-program product. Accordingly, the embodiments may take the form of a hardware embodiment, or an embodiment combining software and hardware. An embodiment takes the form of a computer-program product that includes computer-useable instructions embodied on one or more computer-readable media that may cause one or more computer processing components to perform particular operations or functions.

Computer-readable media include both volatile and nonvolatile media, removable and nonremovable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions – including data structures and program modules – in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

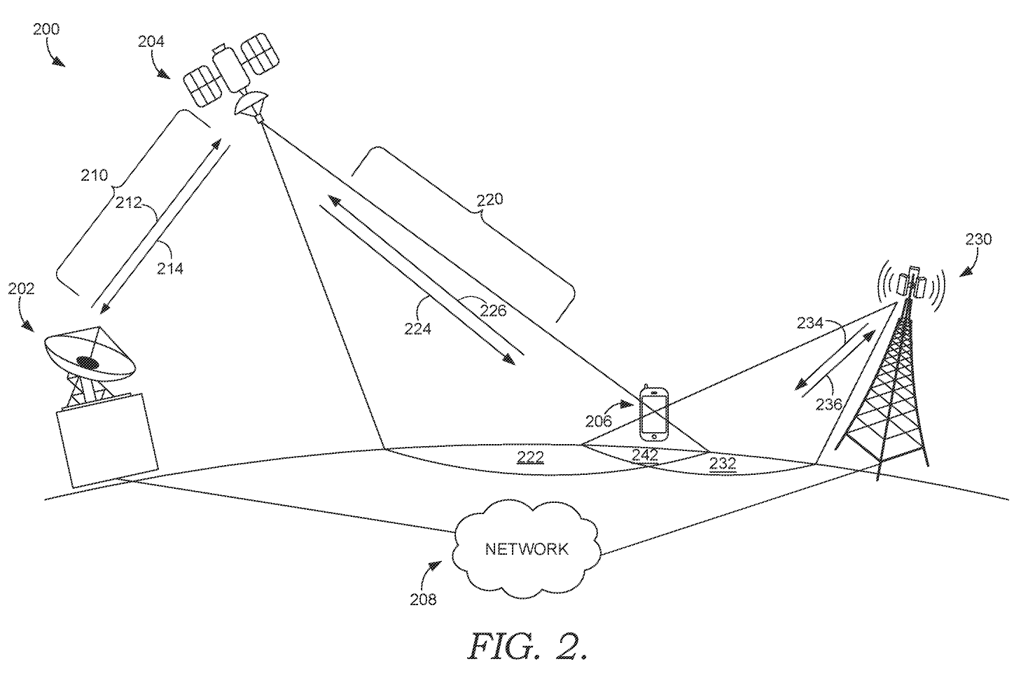

Turning now to FIG. 2, a network environment 200 is depicted, within which implementations of the present disclosure may be utilized. The network environment 200 comprises one or more of a satellite radio access network (RAN) and a terrestrial RAN, a user equipment (UE) 206, and a network 208. When present, the satellite RAN includes at least a gateway 202 and a satellite 204, while the terrestrial RAN, when present, includes at least a terrestrial base station 230. The network environment 200 is illustrated as including singular instances of various components for clarity; however, multiple instances of each component are anticipated. For example, the network environment 200 may include multiple gateways, multiple satellites with or without inter-satellite links (ISLs), multiple terrestrial base stations, multiple UEs, and multiple distinct networks, any of which may be interconnected, federated, virtualized, or otherwise structured to provide seamless connectivity, mobility, and service continuity.

Though illustrated as a mobile phone, the UE 206 may be any communication-capable device having one or more features, components, or characteristics of the computing device 100 of FIG. 1. In non-limiting examples, the UE 206 may be a tablet, laptop, desktop computer, connected consumer electronic device (e.g., smart TV), embedded module, IoT sensor, vehicle, aerial drone, smart wearable, industrial machine, or computing node in an edge computing framework. The UE 206 may support one or more wireless communication protocols, including 3GPP-based cellular access technologies (e.g., LTE, NR, 6G), unlicensed spectrum protocols (e.g., 802.11 Wi-Fi, Bluetooth, UWB, Zigbee, LoRaWAN), and/or satellite-specific protocols (e.g., DVB-S2, DVB-RCS2, CCSDS, proprietary waveforms). The UE 206 may be configured to operate in various mobility scenarios, including stationary, pedestrian, vehicular, airborne, or maritime mobility profiles, and may support adaptive transmission parameters such as beamforming, dynamic frequency selection, carrier aggregation, dual connectivity, multi-RAT coordination, and heterogeneous network (HetNet) offloading.

The network 208 may comprise one or more interconnected networks and may include, individually or in combination, a cellular core network, an IP Multimedia Subsystem (IMS) network, or other packet-switched data networks, such as the Internet, enterprise networks, cloud infrastructures, content delivery networks (CDNs), broadband access networks operated by non-cellular Internet Service Providers (ISPs), or satellite core networks. In aspects wherein the network 208 takes the form of a cellular core network (e.g., a 4G LTE Evolved Packet Core (EPC), a 5G Core (5GC), or a future 6G core network), the network 208 may comprise one or more network functions, including but not limited to an Access and Mobility Management Function (AMF), Session Management Function (SMF), Short Message Service Function (SCSF), User Plane Function (UPF), Policy Control Function (PCF), Network Exposure Function (NEF), Unified Data Management (UDM), Unified Data Repository (UDR), Authentication Server Function (AUSF), Network Repository Function (NRF), Policy Control and Charging Function (PCF), Service Communication Proxy Function (SCPF), Session Management Function (SMF), Security Edge Protection Proxy (SEPP), Network Slice Selection Function (NSSF), Service Capability Exposure Function (SCEF), and one or more gateways (e.g., Packet Data Network Gateway (P-GW), Serving Gateway (SGW), User Plane Gateways, or similar nodes). The network 208 may facilitate capabilities such as mobility management, protocol translation, traffic tunneling, session management, network exposure, security enforcement, authentication, authorization, accounting, policy management, charging, and network slicing. Additionally, the network 208 may interconnect with multiple radio access networks (RANs), each associated with a unique or shared Public Land Mobile Network (PLMN) ID, Mobile Country Code (MCC), Mobile Network Code (MNC), or other identifiers relevant to cellular, satellite, private, hybrid, or non-cellular contexts.

The gateway 202 may be said to be communicatively connected to the network 208 and one or more satellites, such as the satellite 204. The gateway 202 may be connected to the network 208 via one or more wireless or wired connections and is connected to the satellite 204 via a feeder link 210. The gateway 202 may take the form of a device or a system of components configured to communicate with the UE 206 via the satellite 204 and to provide an interface between the network 208 and the satellite 204. Generally, the gateway 202 utilizes one or more antennas to transmit signals to the satellite 204 via a forward uplink 212 and to receive signals from the satellite 204 via a return downlink 214. Each of the forward uplink 212 and the return downlink 214 are wireless connections and may utilize any suitable frequency or protocol.

The satellite 204 provides communication services to the UE 206 while within the satellite coverage area 222. The coverage area 222 may be defined by a beam footprint, which can be statically configured or dynamically adjusted based on traffic demand, UE distribution, interference conditions, atmospheric attenuation, link budget constraints, and/or regulatory considerations. The coverage area 222 is the result of the satellite using spot beams, wide beams, or a hybrid combination of both, depending on the mission profile, orbital altitude, and network architecture. A spot beam is a localized, high-gain transmission beam that focuses radio frequency (RF) energy on a smaller geographic region, allowing for higher spectral efficiency, improved signal-to-noise ratio (SNR), and better frequency reuse across non-overlapping beams. In contrast, a wide beam is a broad-coverage transmission pattern that extends over a large geographical area, typically covering an entire continent, an oceanic region, or a substantial portion of the Earth's visible surface within the satellite’s footprint. Unlike spot beams, which maximize frequency reuse by isolating adjacent beams, wide beams distribute signal power more uniformly across a continuous coverage zone, reducing the need for complex beam-switching mechanisms.

The satellite 204 may operate in bent-pipe (transparent relay) mode, where the satellite simply amplifies and forwards signals between the gateway 202 and the UE 206, or in regenerative (onboard processing) mode, where the satellite performs signal processing, demodulation, re-encoding, routing, and resource scheduling onboard before forwarding data to the gateway 202 or to another satellite via an inter-satellite link (ISL). The user link 220 facilitates direct communication between the satellite 204 and the UE 206, with the forward downlink 224 used for satellite-to-UE transmission and the return uplink 226 used for UE-to-satellite transmission. The user link 220 may support various multiple access schemes, including orthogonal frequency-division multiple access (OFDMA), frequency-division multiple access (FDMA), time-division multiple access (TDMA), spread-spectrum techniques (CDMA, DSSS), and non-orthogonal multiple access (NOMA), enabling flexible spectrum utilization and interference mitigation strategies.

The satellite 204 has an orbital altitude, which may be defined as the distance between the satellite 204 and the Earth’s mean sea level or reference ellipsoid. In aspects, the orbital altitude may be associated with Low Earth Orbit (LEO), Medium Earth Orbit (MEO), or High Earth Orbit (HEO). As the orbital altitude increases, the orbital period (i.e., the amount of time required for the satellite 204 to complete one full orbit around the Earth) also increases. LEO satellites typically have an orbital altitude of less than approximately 2,000 km with orbital periods of approximately 90 to 120 minutes. MEO satellites typically have orbital altitudes between approximately 2,000 km and 35,400 km, and have orbital periods ranging generally from two to twelve hours. HEO satellites typically have an orbital altitude of greater than 35,400km and an orbital period of 24 hours or more. A subset of HEO, known Geostationary Earth Orbit (GEO), are positioned approximately 35,786 km above Earth's equator in order to have orbital periods of approximately twenty-four hours such that they appear to maintain in a stationary position relative to an observer on the Earth’s surface.

The network environment 200 may comprise a terrestrial radio access network (terrestrial RAN), which can operate independently or in combination with a satellite RAN. The terrestrial RAN generally includes one or more terrestrial base stations or access points, represented by terrestrial base station 230, configured to facilitate wireless communication between the UE 206 and the network 208. Although terrestrial base station 230 is illustrated as a macro cell tower for simplicity, it should be understood that terrestrial base station 230 may take numerous other forms, including but not limited to small cells, pico cells, femto cells, relay nodes, repeaters, remote radio heads (RRH), distributed antenna systems (DAS), cloud radio access network (C-RAN) nodes employing virtualized network functions (vRAN), and edge nodes operating at or near network edges. In residential, consumer-grade, or enterprise environments, terrestrial base station 230 may be implemented as a wireless access point (e.g., Wi-Fi access point/router, Wi-Fi mesh node, or wireless LAN controller), a private cellular base station (e.g., private LTE or private 5G small cell), or other networking equipment, such as an IoT gateway, Bluetooth beacon, Zigbee coordinator, LoRaWAN gateway, or ultra-wideband (UWB) anchor node.

The terrestrial base station 230 is configured to communicate bidirectionally with the UE 206 via one or more terrestrial downlinks 234 (base station-to-UE) and terrestrial uplinks 236 (UE-to-base station). The terrestrial base station 230 may operate across licensed, shared, and unlicensed frequency bands, including sub-1 GHz (low-band), mid-band frequencies (1–6 GHz), millimeter-wave (mmWave) frequencies (24 GHz and above), and future-oriented terahertz (THz) or optical spectrum envisioned for advanced 6G networks. The terrestrial base station 230 may communicate using any wireless telecommunication protocol desired by a network operator or network administrator, including but not limited to third-generation partnership project (3GPP) standards such as 3G (UMTS/WCDMA), 4G LTE, 5G New Radio (NR), future 6G standards, as well as IEEE 802.11x-based Wi-Fi protocols (e.g., Wi-Fi 4, Wi-Fi 5, Wi-Fi 6/6E, Wi-Fi 7 and later generations), Bluetooth, Bluetooth Low Energy (BLE), Zigbee, Thread, LoRa, NB-IoT, Z-Wave, and other proprietary or standardized short-range communication protocols designed for IoT connectivity.

Terrestrial base station 230 may further support advanced antenna technologies and resource allocation strategies, including multiple-input multiple-output (MIMO) antenna arrays (such as massive MIMO, MU-MIMO, full-duplex MIMO, or distributed MIMO configurations), analog, digital, or hybrid beamforming techniques, beam steering and beam management mechanisms, coordinated multipoint (CoMP) transmission/reception, carrier aggregation, dynamic spectrum sharing (DSS), non-orthogonal multiple access (NOMA), and radio resource management (RRM) algorithms. The terrestrial RAN may be configured using ultra-dense network (UDN) architectures or distributed systems that dynamically manage multiple individual beams to cover distinct or overlapping areas, adapting beam patterns in real-time based on user density, traffic demand, interference conditions, and UE mobility.

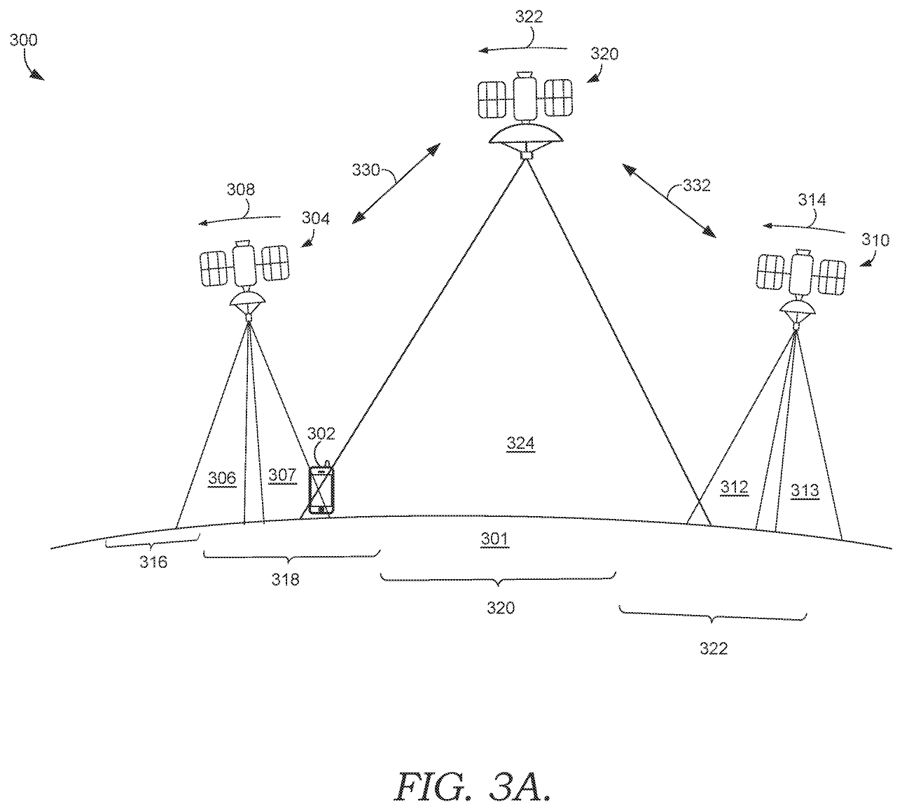

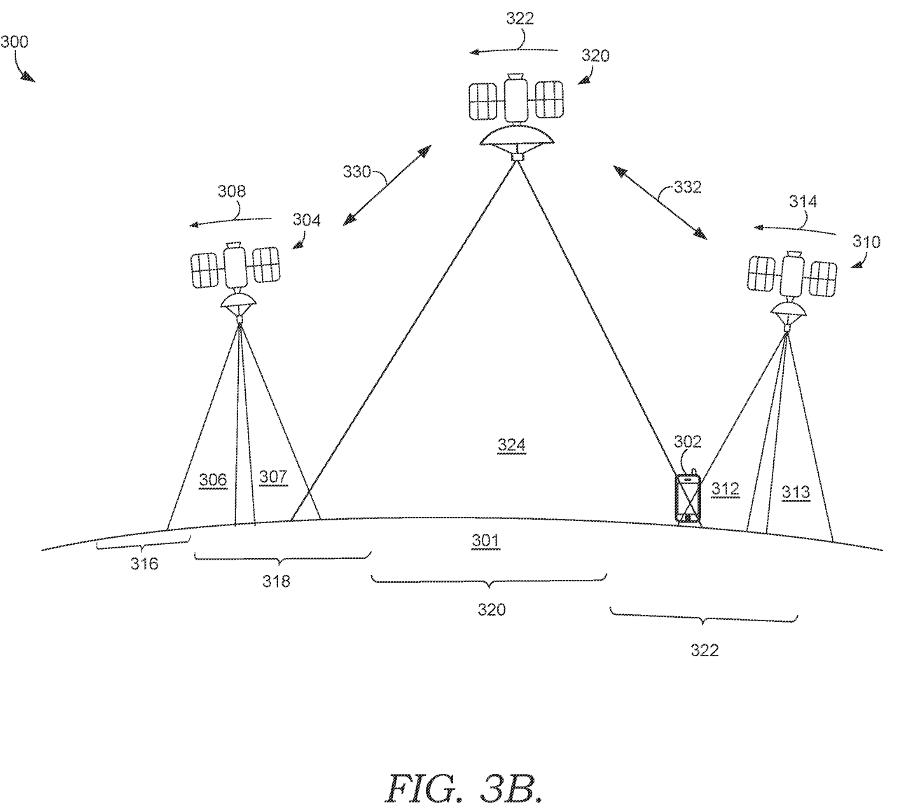

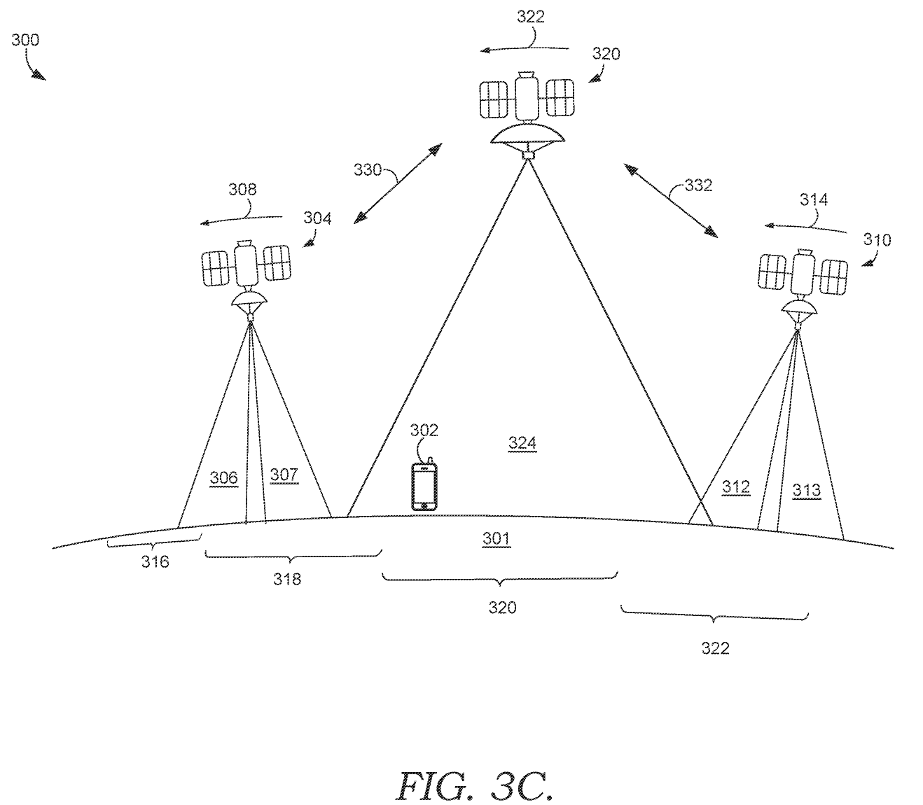

Turning now to FIGS. 3A-3C, a satellite network environment 300 is illustrated in which aspects of the present disclosure may be disclosed. The network environment 300 generally comprises one or more satellites, such as a first satellite 304, a second satellite 310, a third satellite 320, and a UE 302 at or near a surface of the earth 301. The network environment 300 includes one or more components or functions of the network environment 200 of FIG. 2; for example, each of the satellites of the network environment 300 have any one or more aspects of the satellite 204, and the UE 302 of the network environment 300 have any one or more aspects of the UE 206 of network environment 200 in FIG. 2.

The satellite network environment 300 comprises at least one satellite in two different orbital planes. In aspects, such as the one illustrated in FIGS. 3A-3C, each of the first satellite 304 and the second satellite 310 are associated with a first orbital layer (e.g., LEO), and the third satellite 320 is associated with a second orbital layer (e.g., MEO), wherein the first orbital layer has a lower orbital altitude than the second orbital layer. In aspects, each of the satellites of the satellite network environment 300 have a relative motion, relative to the UE 302; as illustrated, the first satellite 304 has a relative motion 308, the second satellite 310 has a relative motion 314, and the third satellite 320 has a relative motion 322. Each satellite in the first orbital layer (i.e., the first satellite 304 and the second satellite 310) is configured to communicate with the UE 302 using a higher frequency than each satellite in the second orbital layer (i.e., the second satellite 320). In one non-limiting example, each of the first satellite 304 and the second satellite 310 may utilize a mid-band frequency (e.g., 1900 MHz, 2100 MHz, or 3500 MHz), and the third satellite 320 may utilize a low-band frequency (e.g., 800 MHz). In aspects, each satellite of the multi-layer constellation may be associated with a common (i.e., same) network identifier (e.g., public land mobile network identifier, service set identifier, etc.); in other aspects, each satellite of the first orbital layer may be associated with a first network identifier and each satellite of the second orbital layer may be associated with a second network identifier, wherein the first network identifier is different than the second network identifier.

In aspects, one or more satellites of the satellite network environment 300 may be configured to support inter-satellite links (ISLs), enabling direct communication between satellites without routing traffic through a ground station. For example, a first ISL 330 may exist between the first satellite 304 and the third satellite 320 and a second ISL 332 may exist between the second satellite 310 and the third satellite 320; other ISLs, such as between satellites of the same orbital layer may also be present (despite not being illustrated in FIGS. 3A-3C). Each ISL may use radio frequency (RF), optical (laser-based), or other suitable communication technologies, and may support full-duplex or half-duplex operation. Each satellite may include an ISL transceiver configured to transmit and receive data to/from one or more neighboring satellites in the same orbital plane or in adjacent planes. The ISLs may be used to relay user-plane or control-plane data, dynamically route traffic based on satellite availability or link quality, and reduce latency by bypassing traditional ground-based backhaul paths. In some embodiments, the satellite may use onboard processing to determine routing decisions across the inter-satellite mesh network.

As illustrated in FIGS. 3A-3C, each satellite of the first orbital layer may utilize different beam shaping strategies. Each of the first satellite 304 and the second satellite 310 may be configured to utilize one or more spot beams, which are a form of satellite coverage beam characterized by a relatively narrow footprint and high gain. In the example shown, the first satellite 304 uses a first spot beam 306 and a second spot beam 307 to provide communication services to a UE within their corresponding coverage areas. Similarly, the second satellite 310 uses a third spot beam 312 and a fourth spot beam 313 to serve additional UEs. In contrast, a third satellite 320 may employ a wide beam 324, which provides a broader coverage area with lower spatial resolution. Broadly, each of satellite of the first orbital layer may utilize a first form of satellite beam (e.g., spot beam), whereas each satellite of the second orbital layer may utilize a second form of satellite beam (e.g., wide beam), wherein the first form of satellite beam is different than the second form of satellite beam.

Referring now to FIGS. 3A–3B, a handover operation is illustrated, wherein the UE 302 experiences a handover between different satellites. In aspects, the UE 302 may perform handover operations between different satellites based on the relative signal quality of satellite coverage beams. With reference to FIG. 3A, the UE 302 may be in communication with the first satellite 304 via a second spot beam 307. As the first satellite 304 continues along its orbital path, the coverage area of the second spot beam 307 may begin to degrade, resulting in a reduction in signal quality observed at the UE 302. The UE 302 may monitor one or more key performance indicators (KPIs) of the serving and neighboring beams, including but not limited to Reference Signal Received Power (RSRP), Reference Signal Received Quality (RSRQ), and/or Signal-to-Interference-plus-Noise Ratio (SINR). The UE 302 may be configured with measurement criteria that is triggered when the signal quality of the serving cell falls below a predefined threshold (e.g., an A2 measurement event).

In some implementations, when the KPI(s) of the serving cell fall below the defined threshold, the UE 302 may initiate a satellite reselection or neighbor search process by scanning a first set of frequencies associated with a first orbital layer (e.g., spot-beam satellites). The UE 302 may monitor these frequencies for the presence of one or more synchronization signals (e.g., PSS/SSS, SSBs) from neighboring satellites. If the UE 302 fails to detect a synchronization signal associated with a cell having KPIs above a cell selection threshold (e.g., a threshold corresponding to minimum coverage quality), then the UE 302 may reconfigure to scan a second set of frequencies corresponding to a second orbital layer (e.g., wide-beam satellites). Upon detection of a synchronization signal from a satellite of the second orbital layer having one or more KPIs that satisfy the minimum threshold, the UE 302 may transmit a measurement report to the serving cell—i.e., the first satellite 304—indicating the degraded condition of the serving beam (second spot beam 307) and optionally the availability of a suitable fallback cell.

Upon receiving the measurement report, the first satellite 304 may evaluate the report to determine whether handover conditions are satisfied. According to the present disclosure, if the UE 302 detects a suitable signal from another satellite of the first orbital layer, then it shall be evaluated with an offset that biases the UE 302 to remain connected to satellites of the first orbital layer. If another satellite of the first orbital layer is not available or is too weak (even accounting for the offset), and if an appropriate target cell is available from a satellite of the second orbital layer (e.g., the wide beam 324 of the third satellite 320) that meets minimum signal criteria, the serving cell (first satellite 304) may transmit a handover command to the UE 302, instructing it to perform a handover to the third satellite 320. The UE 302 may then initiate radio link setup procedures with the third satellite 320, thereby completing the handover.

Referring to FIG. 3B, after completing the handover to the third satellite 320, the UE 302 may continue to monitor neighboring cells as part of ongoing mobility procedures, including measurement of configured frequencies associated with the first orbital layer. While connected to the third satellite 320 via the wide beam 324, the UE 302 may detect synchronization signals associated with a new satellite of the first orbital layer (e.g., the second satellite 310) as it enters the UE's field of view. The UE 302 may begin receiving coverage from one or more beams, such as the third spot beam 312 or the fourth spot beam 313, and may evaluate these signals using configured measurement criteria. In one example, the UE 302 is configured with a trigger condition based on a relative signal quality comparison between a neighboring beam and the serving beam (e.g., an A3 measurement event). Notably, this event does not require degradation of the serving beam; rather, it is triggered when the signal quality of the neighbor beam exceeds that of the serving beam by a predefined offset. Upon detecting that such a condition is satisfied, the UE 302 may transmit a measurement report to its current serving cell—the third satellite 320—indicating that a neighboring beam from the second satellite 310 is suitable for handover. The third satellite 320 may evaluate the report to determine whether the handover condition is satisfied and, if so, transmit a handover command to the UE 302, instructing it to perform a handover to the target beam (e.g., the third spot beam 312) of the second satellite 310. In some implementations, the configuration of the A3 event may include a small offset and/or short time-to-trigger (TTT) value to prioritize and expedite the UE's return to the first orbital layer once a suitable beam becomes available.

The overall handover process of FIGS. 3A-3B (UE-side signal measurement, event-based detection and measurement reporting, serving cell evaluation of the measurement report, and serving cell initiation of handover via an explicit handover command) is repeated for each transition in connectivity as different satellites move into or out of view, and the same signaling framework may be applied regardless of whether the serving beam is a spot beam or a wide beam. Handover decisions are based on standardized measurement events (e.g., A2, A3) and one or more real-time signal key performance indicators (KPIs), such as RSRP, RSRQ, and SINR.

Turning now to FIG. 3C, an initial access operation is illustrated, wherein the UE 302 performs initial radio access network access (during initial connection establishment procedures such as upon power-on, recovery from radio link failure, or when re-entering coverage following a period of radio inactivity). In the scenario illustrated in FIG. 3C, the UE 302 is initially located entirely within the coverage area of a wide beam 324 provided by a third satellite 320 associated with a second orbital layer. However, prior to initiating access to the wide beam 324, the UE 302 may be configured to prioritize access to satellites of a first orbital layer, which may offer higher-capacity spot beam coverage or lower-latency service.

During the initial access procedure, the UE 302 may perform a primary cell search operation to detect and evaluate signals from satellites associated with the first orbital layer. This may include monitoring one or more frequencies associated with the first orbital layer for the presence of downlink synchronization signals (e.g., PSS/SSS or equivalent), attempting synchronization, decoding system information blocks, and measuring one or more signal quality metrics such as RSRP, RSRQ, and/or SINR. If the UE 302 successfully detects one or more cells from the first orbital layer and determines that at least one meets a predefined access threshold (e.g., signal strength or quality above a threshold required for reliable random access), it may initiate initial access procedures with the corresponding cell.

However, if the primary cell search operation fails—for example, if the UE 302 fails to detect any synchronization signals from the first orbital layer, or detects only cells with signal quality below the required access threshold, or if an access attempt is made and fails (e.g., no response to a random access preamble or receiving a connection rejection)—the UE 302 may initiate a secondary cell search operation for a second set of satellites. The secondary cell search operation may comprise monitoring one or more frequencies associated with the second orbital layer for signals transmitted by one or more satellites of that layer. For example, the UE 302 may search for and attempt to synchronize with the wide beam 324 of the third satellite 320.

Upon detecting a signal transmitted by a satellite of the second set of satellites (e.g., wide beam 324), the UE 302 may determine whether the signal meets minimum access criteria, such as signal strength or quality above a defined threshold required to support reliable access procedures. If the signal meets the criteria, the UE 302 may initiate initial access procedures with the satellite of the second set of satellites. The initial access may follow standard procedures (e.g., contention-based or contention-free random access) and may be adapted using different access parameters (e.g., backoff timers, preamble formats, message repetitions) to account for the characteristics of the satellite or beam type.

In some implementations, the prioritization of orbital layers during initial access may be explicitly configured in the UE 302, for example via provisioning, stored configuration, or broadcast system information. The UE 302 may maintain a preference list or search order across orbital layers, enabling it to perform structured initial access that favors certain satellite types (e.g., spot beam satellites in lower orbits) before attempting access to broader-coverage fallback layers (e.g., wide beam satellites in higher orbits). Thus, in the example of FIG. 3C, even though the UE 302 is physically located within the coverage area of the wide beam 324, it may initially perform a primary cell search targeting satellites of the first orbital layer. The fallback to the third satellite 320 and initiation of access with a satellite of the second orbital layer occurs only after the UE 302 determines that the primary cell search operation has failed and that the secondary cell search operation has yielded a signal meeting the access criteria.

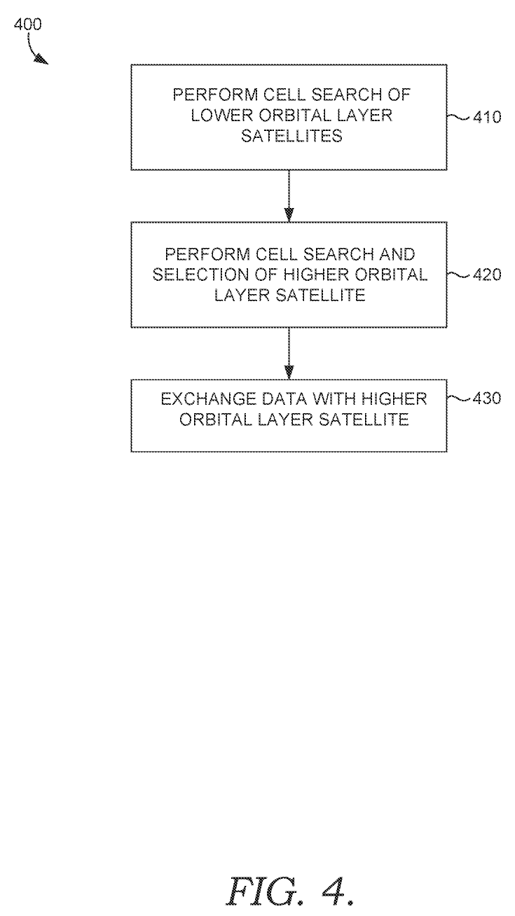

Turning now to FIG. 4, a flow chart is provided to illustrate a method 400 for use with the present disclosure. The method 400 is generally directed to a modified initial access procedure. At a first step 410, a UE performs a cell search and determines that no suitable connection can be established with a lower orbital layer satellite (e.g., due to threshold weak signaling from the lower orbital layer satellite, due to no lower orbital layer satellite being detected, or a threshold number of radio link failures with a lower orbital layer satellite being detected), according to any one or more aspects described with respect to FIGS. 2-3C. At a second step 420, the UE evaluates signaling from a satellite of a higher orbital layer and initiates an initial access procedure based on a determination that one or more criterion for selecting the satellite are satisfied, according to any one or more aspects described with respect to FIGS. 2-3C. At a third step 430, the UE transmits and receives data with the satellite following completion of the initial access procedure, according to any one or more aspects described with respect to FIGS. 2-3C.

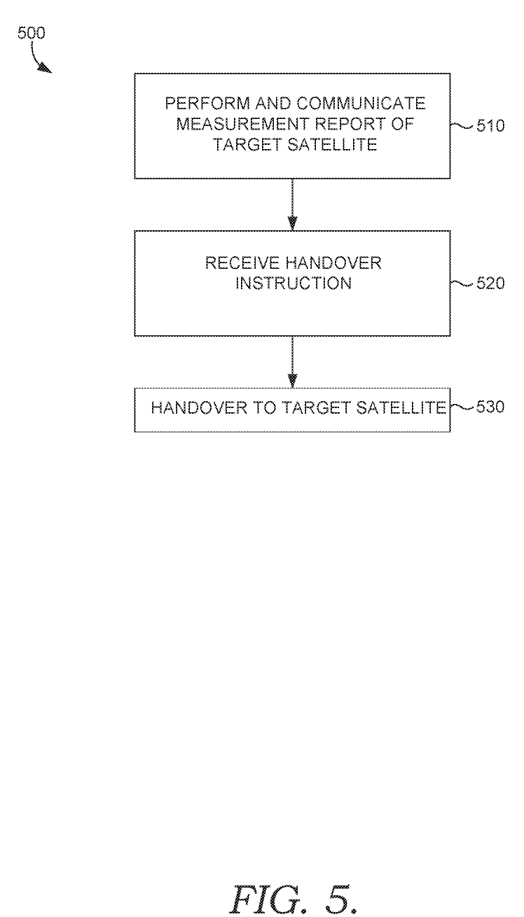

Turning now to FIG. 5, a flow chart is provided to illustrate a method 500 for use with the present disclosure. The method 500 is generally directed to a modified handover procedure. At a first step 510, a UE performs a measurement report and communicates the measurement report to a first satellite (to which the UE is then connected) in response to a determination that one or more KPIs have worsened to be below a predetermined threshold. In aspects, the measurement report is triggered by one or more KPIs of a first set of signals received from the serving cell (first satellite) falling below a predetermined threshold. To perform the measurement report, the UE will first monitor a set of frequencies associated with a first set of satellites in a first orbital layer. Based on a failure of the UE to detect suitable signals from the first set of satellites, the UE will monitor a second set of frequencies associated with a second set of satellites in a second orbital layer (different than the first orbital layer). Upon receiving a signal from a target satellite of the second set of satellites with one or more KPIs greater than another predetermined threshold, the UE will measure and report the signal attributes of the target satellite to the serving satellite. At a second step 520, the UE receives an instruction from the serving satellite to handover to the target satellite, according to any one or more aspects described with respect to FIGS. 2-3C. At a third step 530, the UE transmits and receives data with the second satellite after completing the handover, according to any one or more aspects described with respect to FIGS. 2-3C.

Many different arrangements of the various components depicted, as well as components not shown, are possible without departing from the scope of the claims below. Embodiments in this disclosure are described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

In the preceding detailed description, reference is made to the accompanying drawings which form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the preceding detailed description is not to be taken in the limiting sense, and the scope of embodiments is defined by the appended claims and their equivalents.

What is claimed is:

1. A user equipment (UE) configured to wirelessly communicate with a satellite radio access network, the UE comprising:
one or more antennas configured to wirelessly communicate with the satellite radio access network; and
one or more computer processing components configured to perform operations comprising:
determine, based on a measurement of a first set of signals received from a first satellite, that one or more key performance indicators of the first set of signals are worse than a predetermined threshold;
responsive to said determination, monitor a first set of frequencies for one or more synchronization signals, the first set of frequencies used by a first set of satellites;
based on a failure to detect one or more synchronization signals from the first set of satellites having one or more KPIs greater than a cell selection threshold, monitoring a second set of frequencies for one or more synchronization signals transmitted by a second set of satellites;
communicating a first measurement report to the first satellite that one or more synchronization signals transmitted by a second satellite are greater than the cell selection threshold; and
receiving an instruction from the first satellite to handover to the second satellite.

2. The UE of claim 1, wherein the first set of satellites have a first orbital altitude and the second set of satellites have a second orbital altitude, the second orbital altitude being greater than the first orbital altitude.

3. The UE of claim 2, wherein the first set of frequencies is different than the second set of frequencies, and wherein each frequency of the first set of frequencies is lower than each frequency of the second set of frequencies.

4. The UE of claim 3, wherein subsequent to receiving the instruction from the first satellite to handover to the second satellite, the operations further comprise detecting signals from a target satellite of the first set of satellites, determining the signals from the target satellite of the first set of satellites satisfies a measurement reporting trigger, reporting to the satellite of the second set of satellites one or more measured signal quality values of the signals from the target satellite, and receiving a handover instruction from the second satellite to handover to the target satellite.

5. The UE of claim 4, wherein the measurement reporting trigger comprises one or more KPIs of signals from the target satellite exceeding a minimum value.

6. A method for performing handovers in a wireless network environment comprising:
determine, based on a measurement of a first set of signals received from a first satellite, that one or more key performance indicators of the first set of signals are worse than a predetermined threshold;
responsive to said determination, monitor a first set of frequencies for one or more synchronization signals, the first set of frequencies used by a first set of satellites;
based on a failure to detect one or more synchronization signals from the first set of satellites having one or more KPIs greater than a cell selection threshold, monitoring a second set of frequencies for one or more synchronization signals transmitted by a second set of satellites;
communicating a first measurement report to the first satellite that one or more synchronization signals transmitted by a second satellite are greater than the cell selection threshold; and
receiving an instruction from the first satellite to handover to the second satellite.

7. The method of claim 6, wherein the first set of satellites have a first orbital altitude and the second set of satellites have a second orbital altitude, the second orbital altitude being greater than the first orbital altitude.

8. The method of claim 7, wherein the first set of frequencies is different than the second set of frequencies, and wherein each frequency of the first set of frequencies is lower than each frequency of the second set of frequencies.

9. The method of claim 8, wherein subsequent to receiving the instruction from the first satellite to handover to the second satellite, the method further comprises detecting signals from a target satellite of the first set of satellites, determining the signals from the target satellite of the first set of satellites satisfies a measurement reporting trigger, reporting to the satellite of the second set of satellites one or more measured signal quality values of the signals from the target satellite, and receiving a handover instruction from the second satellite to handover to the target satellite.

10. The method of claim 9, wherein the measurement reporting trigger comprises one or more KPIs of signals from the target satellite exceeding a minimum value.

11. A method for performing initial access in a wireless network environment comprising:
performing a primary cell search operation for a first set of satellites, the primary cell search operation comprising monitoring one or more frequencies for signals transmitted by a satellite of the first set of satellites;
determining the primary cell search operation failed;
responsive to the primary cell search operation failing, performing a secondary cell search operation for a second set of satellites, the secondary cell search operation comprising monitoring one or more frequencies for signals transmitted by a satellite of the second set of satellites;
determining that the signals transmitted by the satellite of the second set of satellites meets a minimum access criteria; and
responsive to said determination, initiating initial access with the satellite of the second set of satellites.

12. The method of claim 11, wherein the first set of satellites is associated with a first orbital plane and the second set of satellites is associated with a second orbital plane, the first orbital plane being different than the second orbital plane.

13. The method of claim 12, wherein the first orbital plane has a lower orbital altitude than the second orbital plane.

14. The method of claim 13, wherein the first orbital plane is low earth orbit and the second orbital plane is medium earth orbit.

15. The method of claim 11, wherein the first set of satellites transmits signals using a first set of frequencies and wherein the second set of satellites transmits signals using a second set of frequencies, each frequency of the first set of frequencies being different than each frequency of the second set of frequencies.

16. The method of claim 15, wherein the primary cell search operation comprises monitoring the first set of frequencies and not monitoring the second set of frequencies, and wherein the secondary cell search operation comprises monitoring the second set of frequencies and not monitoring the first set of frequencies.

17. The method of claim 11, wherein subsequent to initiating initial access with the satellite of the second set of satellites, the method further comprises detecting signals from a target satellite of the first set of satellites, determining the signals from the target satellite of the first set of satellites satisfies a measurement reporting trigger, reporting to the satellite of the second set of satellites one or more measured signal quality values of the signals from the target satellite, and receiving a handover instruction from the satellite of the second set of satellites to handover to the target satellite.

18. The method of claim 11, wherein determining the primary cell search operation failed comprises a failure to detect any signal from the first set of satellites.

19. The method of claim 11, wherein determining the primary cell search operation failed is based on a measurement that the signals transmitted by the satellite of the first set of satellites have one or more signal quality metrics below a predetermined access threshold.

20. The method of claim 11, wherein determining the primary cell search operation failed is based on an access attempt failure, wherein the access attempt failure comprises not receiving a response to a random access preamble or receiving a connection rejection from the satellite of the first set of satellites.
